(19) United States
(12) Patent Application Publication
(10) Pub. No.: US 2025/0372915 A1
(43) Pub. Date: Dec. 4, 2025

(54) ANGLE CONNECTOR SLEEVE WITH PUSH-OUT OPENING

(71) Applicant: Neutrik AG, Schaan (LI)

(72) Inventor: Oliver DOBLER, Tschagguns (AT)

(73) Assignee: Neutrik AG, Schaan (LI)

(21) Appl. No.: 19/200,058

(22) Filed: May 6, 2025

(30) Foreign Application Priority Data
May 31, 2024 (EP) 24179395.9

(51) Int. Cl. H01R 13/512; H01R 13/10; H01R 13/516

(52) U.S. Cl. CPC H01R 13/512; H01R 13/10; H01R 13/516

(57) ABSTRACT

An angle connector sleeve, configured as a housing for a cable connector which can be inserted into a built-in connector matched as a counterpart to form a mechanically lockable plug connection. The cable connector is insertable into the built-in connector with a plug-in end of a plug-in assembly to form the plug connection. The angle connector sleeve is configured to receive and enclose at least the plug-in assembly, and has an angled hollow body, with a first sleeve part and a second sleeve part. The first sleeve and second sleeve parts can be joined together along a contact surface running through the angle connector sleeve, and the first sleeve part has a push-out opening configured such that the plug-in end of the plug-in assembly can be pushed out through the push-out opening from the first sleeve part, and the push-out opening is completely surrounded radially by the first sleeve part.

### CROSS-REFERENCE TO RELATED APPLICATIONS

This application claims priority from European Patent Application No. 24179395.9, filed May 31, 2024, which is incorporated by reference herein in its entirety as if fully set forth.

### TECHNICAL FIELD

The present invention relates to an angle connector sleeve which is configured as a housing for a cable connector which can be inserted into a built-in connector matched as a counterpart to form a mechanically lockable plug connection.

### BACKGROUND

Angle connector sleeves for converting a straight cable connector, in which the individual components are arranged along a common longitudinal axis, into an angled cable connector, in which certain components, such as the plug-in end, are then directed towards a second longitudinal axis that intersects the original common longitudinal axis, are known from the prior art. Depending on the configuration of the angle connector sleeve, angled cable connectors with various angles can be obtained, with the right-angled variant being frequently implemented. In addition to their use in such conversion kits/retrofitting sets, these angle connector sleeves can also be used as a pre-provided housing in the manufacture of angled cable connectors.

Such angle connector sleeves are frequently formed in two parts, with the two sleeve parts being configured in such a manner that they can be joined together at a contact surface running through the angle connector sleeve and, in particular, can be separated again at this contact surface, which can then also be designated as a separating surface. The other components of the cable connector, such as the plug-in assembly with the plug-in end and the contact element carrier, are placed in or on the first sleeve part and fixed in or on the housing formed thereby by fastening the second sleeve part to the first sleeve part.

In the case of angle connector sleeves of the prior art, the second sleeve part is frequently configured as an insertion element which is, for example, inserted into corresponding grooves of the first sleeve part, wherein with such a configuration of the fastening mechanism the second sleeve part can easily be pushed out again in the opposite direction to the insertion direction, which can occur precisely when the cable connector is pulled across the floor.

The two sleeve parts are also frequently configured in such a manner that the contact surface runs through or cuts through the angle connector sleeve-when viewed from the front towards the plug-in end-sagittally, i.e. from front to back. With such a configuration, however, openings in the angle connector sleeve, e.g. the cable feed-through opening, are also passed through by the contact surface, as a result of which the area of the angle connector sleeve radially surrounding the corresponding opening is severed and thus loses stability. Such a loss of stability at the openings in the angle connector sleeve, in particular at the plug-in end, which bears a large part of the force in the event of a tear at the cable connector when plugged in, can then lead to the angle connector sleeve tearing open along the contact surface when the cable connector is subjected to mechanical stress, with the result that the angle connector sleeve and the other components of the cable connector can become damaged and/or the connection to the built-in connector can become loose.

State-of-the-art angle connector sleeves or angled cable connectors are frequently configured in such a manner that the plug-in end, which has the characteristic features for a respective connector type that ultimately enable the precise fit of the mechanically lockable plug connection into the built-in connector matched as a counterpart, such as the radial extension/size and geometric shape of the plug-in end, the positioning and configuration of any mechanical retaining elements or key elements, etc., is formed as part of the angle connector sleeve. The plug-in assembly, which includes, inter alia, the contact element carrier, is located inside the angle connector sleeve. However, such a configuration of the angle connector sleeve or cable connector, in which the angle connector sleeve itself has the plug-in end, has the disadvantage that the angle connector sleeve can only be used as a housing for a specific cable connector type, such as cable connectors for data transmission (e.g., RJ45 connectors, etc.) or cable connectors for transmitting electrical energy (XLR connectors, powerCON connectors, etc.). Consequently, it is necessary to produce many different angle connector sleeves for the respective cable connector types.

There is therefore a need for angled connector sleeves that can be used for a variety of different cable connector types and thus can be used flexibly, and/or protect the angled cable connector or its individual components from damage under mechanical stress. Consequently, there is also a need for cable connectors that have such an angle connector sleeve as a housing.

### SUMMARY

It is therefore an object of the invention to provide an angle connector sleeve and a cable connector which overcome the disadvantages of the prior art.

A further object is to provide an angle connector sleeve that can be used flexibly, in particular for a plurality of different cable connector types.

A further object is to provide a cable connector that has a flexibly usable housing.

A further object is to provide an angle connector sleeve that enables protection against damage, in particular under mechanical stress.

Another object is to provide a cable connector with a stable structure.

These objects are achieved by implementing at least some of the features disclosed herein. Features that further develop the invention in an alternative or advantageous manner can be found in the description and claims that follow.

The invention relates to an angle connector sleeve which is configured as a housing for a cable connector which can be inserted into a matching built-in connector to establish a mechanically lockable plug connection, wherein the cable connector is configured to be inserted into the built-in connector with a plug-in end of a plug-in assembly to establish the plug connection, the angle connector sleeve is configured to receive and enclose at least the plug-in assembly, is configured as a hollow body which is angled, in particular at a right angles, and has a first sleeve part and a second sleeve part, the first sleeve part and the second sleeve part can be joined together along a contact surface running through the angle connector sleeve, and the first sleeve part has a push-out opening, wherein the push-out opening is configured in such a manner that the plug-in end of the plug-in assembly can be pushed out of the first sleeve part through the push-out opening, wherein the push-out opening is completely radially surrounded by the first sleeve part.

The feature “completely radially surrounded by the first sleeve part” should not be understood to mean that the push-out opening is 100% surrounded radially by the first sleeve part or that the material of the first sleeve part is configured to be compact in a region of the first sleeve part that limits the radial extension of the push-out opening, i.e., for example, without recesses, notches, etc. This term should rather be understood to mean that the first sleeve part runs around the push-out opening as a whole along a large part of the circumference of the push-out opening, i.e., for example, over 60%, in particular over 80%, but the push-out opening is not surrounded by the second sleeve part. Smaller recesses, notches, etc. in the first sleeve part are certainly possible, provided that the material of the first sleeve part surrounds the push-out opening to a large part. In the configuration of an angle connector sleeve in which the first and second sleeve parts can be contacted or separated in such a manner that the push-out opening is also partially surrounded by the second sleeve part, the push-out opening is consequently not completely radially surrounded by the first sleeve part. Such a configuration of the angle connector sleeve exists, for example, when the contact surface or separating surface runs through the angle connector sleeve as a cut surface extending, in particular perpendicularly, intersecting the push-out opening.

Furthermore, the feature “radially completely surrounds” is not understood to mean that the first sleeve part must surround the push-out opening in a circular manner. Thus, depending on the configuration of the hollow body of the angle connector sleeve, e.g., as a hollow cylinder or hollow cuboid, the push-out opening can be circular, rectangular, in particular square, hexagonal, etc., whereby the first sleeve part surrounding the push-out opening, which accordingly partially forms the lateral surface of the hollow body, is shaped accordingly around the push-out opening, thus radially surrounds the push-out opening with a corresponding shape, which does not necessarily have to be circular.

The feature “is configured to receive and enclose at least the plug-in assembly” is not understood to mean that the angle connector sleeve must be configured to completely enclose all parts of the plug-in assembly and thus completely “conceal” them within the angle connector sleeve. The angle connector sleeve also exhibits the said suitability when parts of the plug-in assembly, such as the plug-in end pushed out through the push-out opening, are located outside the angle connector sleeve, while other parts of the plug-in assembly are received and enclosed by the angle connector sleeve.

The term “angled hollow body” is understood to mean a body in which a second section of the body does not run along the same longitudinal axis as the first section (in a straight body, however, both sections run along the same longitudinal axis). The second section of the body runs along its own longitudinal axis, which crosses the longitudinal axis of the first section, in particular including an angle in the range of 45 degrees to 100 degrees, in particular 90 degrees. If the angle connector sleeve is shaped in such a manner that it encloses an angle of 90 degrees, the angle connector sleeve is configured as a hollow body angled at a right angle. The cavity inside the angle connector sleeve configured as a hollow body also extends with an angled course corresponding to the angle enclosed by the angle connector sleeve.

In the configuration of the angle connector sleeve according to the invention, when at least the plug-in assembly is received and enclosed by the angle connector sleeve, the plug-in end of the plug-in assembly is pushed out of the first sleeve part through the push-out opening, with the result that the features characteristic of a respective connector type, which ultimately enable the precise insertion of the mechanically lockable plug connection into the built-in connector matched as a counterpart, such as the radial extension/size and geometric shape of the plug-in end, the positioning and configuration of possible mechanical retaining elements or key elements, etc., are present outside the angle connector sleeve. Furthermore, said characteristic features are not part of the angle connector sleeve, but are “brought along” by the corresponding plug-in assembly or the plug-in end.

The angle connector sleeve according to the invention thus has the advantage that it can be used as a housing for a plurality of cable connectors, such as cable connectors for data transmission (e.g. RJ45 connectors, etc.) or cable connectors for transmitting electrical energy (XLR connectors, powerCON connectors, etc.). Consequently, it is no longer necessary to produce many different angle connector sleeves for the respective cable connector types, which in turn saves production lines and thus investment costs. In addition, it is now sufficient to have only the angle connector sleeve according to the invention in stock in order to be able to replace damaged angle connector sleeves or to convert a straight cable connector into an angled one, whereas for such a replacement or conversion with angle connector sleeves of the prior art, a correspondingly large number of different angle connector sleeves must be in stock. Thus, the angle connector sleeve according to the invention can be used flexibly, in particular as a standard housing for the production of a large number of angled cable connectors and/or as a component of a “conversion kit” for converting straight into angled cable connectors.

Furthermore, in the case of the angle connector sleeve according to the invention, since the push-out opening is completely radially surrounded by the first sleeve part, the part of the plug-in assembly arranged at the plug-in end pushed through the push-out opening, in particular the contact element carrier, which is located within the angle connector sleeve and is thus surrounded by the angle connector sleeve, is also completely radially surrounded by the first sleeve part, which in turn leads to a compact, stable and protective enclosure of this part of the plug-in assembly by the angle connector sleeve. A stable and protective enclosure of the plug-in assembly by the angle connector sleeve is particularly advantageous since it significantly reduces the likelihood of damage to the plug-in assembly and/or the angle connector sleeve compared to angle connector sleeves of the prior art. Thus, specifically if a cable of the cable connector or the cable connector itself is torn when plugged in, or if the cable connector receives an impact, the majority of the resulting force acts on the plug-in assembly, in particular the plug-in end but the force can be distributed over the entire cable connector due to the firm and compact enclosure of the plug-in assembly by the first sleeve part via the angle connector sleeve, with the result that damage, in particular breakage, to the plug-in assembly is prevented. Furthermore, the fact that the push-out opening is completely radially surrounded by the first sleeve part ensures that the contact surface or separating surface between the first and second sleeve parts cannot run as a cutting surface extending, in particular perpendicularly, intersecting the push-out opening, whereby a further potential weak point at which damage could occur in the angle connector sleeve according to the invention is eliminated.

In an exemplary embodiment of the angle connector sleeve according to the invention, the first sleeve part can have a fixing element and the second sleeve part can have a fixing element counterpart matched to the fixing element, wherein the fixing element is provided to engage, in particular the hammer-shaped part of the fixing element, in the fixing element counterpart matched to the fixing element, in particular to the hammer-shaped part of the fixing element, as part of a fixing mechanism, in particular with a hammer-shaped part, and the fixing element counterpart is provided to engage behind the fixing element as part of the fixing mechanism, and thus to fix the second sleeve part to the first sleeve part.

In a further embodiment of the angle connector sleeve according to the invention, the fixing element can be provided to engage in the fixing element counterpart and to cooperate with the fixing element counterpart in such a manner that a first rotary joint can be provided, about which the second sleeve part can be rotated relative to the first sleeve part.

In a further embodiment of the angle connector sleeve according to the invention, the fixing element can be provided in such a manner that it engages with a hammer-shaped part in the fixing element counterpart matched to the hammer-shaped part of the fixing element and cooperates with the fixing element counterpart in such a manner that a rotation axis of the first rotary joint, about which the second sleeve part can be rotated relative to the first sleeve part, runs through the hammer-shaped part of the fixing element, in particular along a longitudinal axis of the hammer-shaped part of the fixing element.

In a further embodiment of the angle connector sleeve according to the invention, by engagement of the fixing element in the fixing element counterpart and engagement of the fixing element counterpart behind the fixing element, the second sleeve part can be blocked with respect to an axial movement in a first direction of movement, wherein the first direction of movement runs counter to a push-out direction of the plug-in end of the plug-in assembly from the first sleeve part, and/or blocked with respect to an axial movement in a second direction of movement, wherein the second direction of movement crosses the first direction of movement, in particular including an angle in the range of 45 degrees to 100 degrees, in particular of 90 degrees, and/or blocked with respect to an axial movement in a third direction of movement, wherein the third direction of movement runs counter to the second direction of movement.

In a further embodiment of the angle connector sleeve according to the invention, by rotating the second sleeve part about the first rotary joint, in particular about the axis of rotation of the first rotary joint, in a first direction of rotation predetermined by the first rotary joint, in particular by the axis of rotation of the first rotary joint the second sleeve part can be joined to the first sleeve part along the contact surface running through the angle connector sleeve, and/or the fixing element counterpart can engage behind the fixing element, in particular the hammer-shaped part of the fixing element, in such a manner that the second sleeve part is blocked with respect to an axial movement in a first direction of movement, wherein the first direction of movement runs counter to a push-out direction of the plug-in end of the plug-in assembly from the first sleeve part, and/or the fixing element, in particular the hammer-shaped part of the fixing element, can engage in a recess of the fixing element counterpart matched to the fixing element in such a manner that the second sleeve part is blocked with respect to an axial movement in a second direction of movement, wherein the second direction of movement crosses the first direction of movement, in particular including an angle in the range of 45 degrees to 100 degrees, in particular of 90 degrees, and/or is blocked with respect to an axial movement in a third direction of movement, wherein the third direction of movement is opposite to the second direction of movement.

In a further embodiment of the angle connector sleeve according to the invention, the fixing element of the first sleeve part and the fixing element counterpart of the second sleeve part can cooperate in such a manner that when the first sleeve part and the second sleeve part are joined together, the second sleeve part coincides with the first sleeve part.

These embodiments of the angle connector sleeve according to the invention have the advantage over angle connector sleeves from the prior art that, thanks to the special fixing mechanism, which provides for engagement of the fixing element and engagement behind the fixing element counterpart, assembly of the two sleeve parts is only possible by means of a special fixing movement, in particular a rotational movement about the first rotary joint, and thus a separation of the two sleeve parts is only possible by means of a special opposite separating movement with the result that, after the two sleeve parts have been assembled, the second sleeve part is blocked with respect to axial movement in up to three directions. In this way, the two sleeve parts are stably fixed to one another even under mechanical stress, which is why the angle connector sleeve according to the invention and the parts of the cable connector accommodated by the angle connector sleeve according to the invention are protected from damage. In the case of angle connector sleeves of the prior art, the second sleeve part is frequently configured as an insertion element which is, for example, inserted into corresponding grooves of the first sleeve part, wherein with such a configuration of the fixing mechanism the second sleeve part can easily be pushed out again in the opposite direction to the insertion direction, which can easily occur when the cable connector is pulled across the floor.

In a further embodiment of the angle connector sleeve according to the invention, the angle connector sleeve can have a locking slider, which is provided to engage, within the framework of a first locking mechanism that can be actuated by moving the locking slider, with a bolt connected to the locking slider in a locking element on the built-in connector side and thus blocks the cable connector from rotating in the unscrewing direction, which is opposite to the screwing direction. Such a locking slider, due to its size and accessibility, provides simplified actuation and release of said locking mechanism compared to locking mechanisms that operate with small push buttons or pins.

In a further embodiment of the angle connector sleeve according to the invention, the fixing element can be configured and arranged on the first sleeve part in such a manner that the locking slider can be arranged on the fixing element and can be moved along the fixing element parallel to the insertion direction of the cable connector into the built-in connector.

This embodiment of the angle connector sleeve according to the invention has the advantage that the locking slider can be easily mounted on the angle connector sleeve without the need to equip the angle connector sleeve with an additional rail for the locking slider. This allows the angle connector sleeve to be manufactured more easily and quickly.

In a further embodiment of the angle connector sleeve according to the invention, the cable connector can comprise: a contact element carrier formed as part of the plug-in assembly and arranged at the plug-in end, configured to receive a contact element and thus fix it within the cable connector, and/or the contact element, wherein the contact element is provided to come into contact with a contact element counterpart on the built-in connector side by forming the mechanically lockable plug connection and thereby to provide a signal transmission across the plug connection, and/or a cable, provided to be connected to the contact element, and/or a through-opening for the cable to pass through, and/or a clamping sleeve, wherein the clamping sleeve has an axial lead-through for the cable and is configured to be pressed against the cable passed through the through-opening and through the clamping sleeve and thereby to block the cable with respect to an axial movement in the cable withdrawal direction, and/or a union nut, configured to be screwed onto a thread arranged on an outer lateral surface of the angle connector sleeve, whereby the clamping sleeve can be pressed onto the cable passed through the clamping sleeve.

In a further embodiment of the angle connector sleeve according to the invention, the second direction of movement can run counter to the cable withdrawal direction, and/or the third direction of movement can run in the cable withdrawal direction. This allows for a more stable fixing of the second sleeve part to the first sleeve part compared to the prior art, in which the second sleeve part is configured as an insertion element.

In a further embodiment of the angle connector sleeve according to the invention, before at least the plug-in assembly is received and enclosed by the angle connector sleeve, the cable connector can have such a first arrangement of components that the plug-in end is directed in the axial direction of a longitudinal axis of the cable connector, and by receiving and enclosing at least one plug-in assembly by the angle connector sleeve, can have such a second arrangement of components that the plug-in end is directed in the axial direction of a second axis which crosses the original longitudinal axis, in particular including an angle in the range of 45 degrees to 100 degrees, in particular of 90 degrees, wherein at least one further component of the cable connector, in particular a clamping sleeve and/or a union nut, is still directed in the axial direction of the longitudinal axis of the cable connector. Thus, the angled connector sleeve according to the invention can be used to convert a straight cable connector, in which the various components are arranged along the longitudinal axis, into an angled cable connector.

In a further embodiment of the angle connector sleeve according to the invention, the contact element can be received by the contact element carrier formed as part of the plug-in assembly and arranged at the plug-in end, and the cable can be connected to the contact element and during the process of receiving and enclosing at least the plug-in assembly by the angle connector sleeve, a connection between the cable and the contact element does not have to be broken. Thus, the angle connector sleeve according to the invention allows for easy conversion of the cable connector.

In a further embodiment of the angle connector sleeve according to the invention, the cable connector can be configured as a 3-pin power connector (e.g., a powerCON connector from Neutrik AG in Liechtenstein) or as one of the following cable connector types: IEC, XLR, RJ45, HDMI, USB, or RCA. This embodiment underscores how flexibly the angled connector sleeve according to the invention can be used as a housing for a plurality of different cable connector types.

In a further embodiment of the angle connector sleeve according to the invention, the angle connector sleeve can consist (at least predominantly) of plastic.

The plastic configuration of the angle connector sleeve according to the invention has the advantage that it can be easily and cost-effectively produced in large quantities using additive manufacturing processes, such as 3D printing, or by means of injection moulding. Furthermore, even complex structures on the angle connector sleeve according to the invention, such as the fixing element, can be easily manufactured.

This embodiment does not necessarily require that all parts of the angled connector sleeve be made of plastic. Individual parts, such as the fixing element, the insertion element, etc., can certainly be made of a different material, such as metal or carbon, as long as the majority of the angle connector sleeve, i.e. over 60%, in particular 80%, consists of plastic. This embodiment requires in particular that the first sleeve part and the second sleeve part consists of plastic. The angle connector sleeve according to the invention can be made of a single plastic or of a mixture of several plastics. Furthermore, additives such as flame retardants, plasticizers, etc., can be mixed into the one or more plastics.

In a further embodiment of the angle connector sleeve according to the invention, the plastic can be a thermoplastic, in particular one of the following thermoplastics: polypropylene, polyethylene, polyurethane, or polystyrene.

The use of a thermoplastic as the main component for the material of the angle connector sleeve according to the invention has, inter alia, the advantage that production can be carried out by means of injection moulding, pressing or vulcanization and that the angle connector sleeve has an insulating effect against electrical current.

Advantages of manufacturing the angle connector sleeve according to the invention using an injection moulding process are that, on the one hand, the injection moulding process allows for high-precision manufacturing and, on the other hand, that various components (e.g., plastic and flame retardant) can be mixed together in different proportions in a “recipe-like” manner. Subsequently, it can then be checked whether the final product exhibits the desired material properties with the used recipe, and the recipe can be adjusted if necessary.

In a further embodiment of the angle connector sleeve according to the invention, the first sleeve part, which is located in front of the contact surface when looking towards the push-out opening, can be configured with a first subregion and a second subregion, wherein the first and the second subregion can be arranged in such a manner that they enclose an angle in the range of 45 degrees to 100 degrees, in particular of 90 degrees, wherein the first subregion can be configured as a completely encased hollow body, in particular a hollow cylinder or hollow cuboid, and the second subregion can be configured as a half-shell, in particular open on one side, and the second sleeve part, which is located behind the contact surface when looking towards the push-out opening, can be configured as a half-shell, in particular open on one side.

Since the first subregion of the first sleeve part can be configured as a (at least largely) completely encased hollow body, wherein a hollow body with, for example, smaller recesses and notches is understood to be “completely encased,” it can be ensured that the contact surface or separating surface of the angle connector sleeve according to the invention cannot run through the first subregion. This gives the first subregion additional stability under mechanical stress, since a contact surface or separating surface represents a weak point that can tear more easily under mechanical stress than with a compact configuration. Thus, at least the plug-in assembly can be stably and securely received in the first subregion of the first sleeve part, whereby the angle connector sleeve according to the invention enables improved protection against damage, particularly under mechanical stress.

In a further embodiment of the angle connector sleeve according to the invention, the fixing element of the first sleeve part and the fixing element counterpart of the second sleeve part can cooperate in such a manner that when the first sleeve part and the second sleeve part are joined together, the second sleeve part configured as a half-shell coincides with the second subregion of the first sleeve part configured as a half-shell.

In a further embodiment of the angle connector sleeve according to the invention, the first subregion of the first sleeve part can have the push-out opening and/or, when the first sleeve part and the second sleeve part are joined together, the second subregion of the first sleeve part, which is configured as a half-shell, in particular open on one side, and the second sleeve part, which is configured as a half-shell, in particular open on one side, can form a through-opening for the passage of a cable.

These embodiments of the angle connector sleeve according to the invention have the advantage that the corresponding components are configured and positioned in such a manner that the first and second sleeve parts can be precisely joined together without complex alignment.

In a further embodiment of the angle connector sleeve according to the invention, the second subregion of the first sleeve part and the second sleeve part can have a part of a thread on a respective outer lateral surface, wherein, when the first sleeve part and the second sleeve part are joined together, the parts of the thread can be arranged in such a manner that a union nut can be screwed onto the thread, wherein the union nut can be configured to fix the second sleeve part to the first sleeve part. Thus, the union nut serves, for example, in addition to other fixing components, such as the fixing element and the fixing element counterpart, to provide additional fixing and thus stabilization of the second sleeve part on the first sleeve part, whereby the angle connector sleeve according to the invention enables improved protection against damage, in particular under mechanical stress.

In a further embodiment of the angle connector sleeve according to the invention, the first subregion can have a rotating arrangement, in particular a second rotary joint, wherein the rotating arrangement enables the second subregion to be rotated relative to the first subregion, in particular wherein the second subregion can be rotated about an axis of rotation running coaxially to a central axis of the first subregion. Thus, the angled part of the angle connector sleeve according to the invention, which in particular defines the direction of the cable outlet, can be flexibly rotated and positioned, which is particularly advantageous when many angled cable connectors are to be plugged next to one another into a device panel provided with closely spaced built-in connectors, since in this way, for example, an interfering cable can be rotated out of the insertion path.

In a further embodiment of the angle connector sleeve according to the invention, a first elevation can be arranged within the first sleeve part, intended to provide a stop for a second elevation arranged on the plug-in assembly, in particular on a contact element carrier, whereby the plug-in end can only be pushed out of the first sleeve part by a defined length through the push-out opening.

In a further embodiment of the angle connector sleeve according to the invention, the second sleeve part can have an insertion element configured to be inserted, in particular in an abutting manner, into the first sleeve part and thus to align the second sleeve part with respect to the first sleeve part, in particular in such a manner that the second sleeve part configured as a half-shell coincides with the second subregion of the first sleeve part configured as a half-shell.

In a further embodiment of the angle connector sleeve according to the invention, the insertion element can be configured to strike the plug-in assembly, in particular the contact element carrier, when inserted into the first sleeve part and to thereby insert the plug-in assembly so far into the first sleeve part that the second elevation arranged on the plug-in assembly, in particular on the contact element carrier, strikes the first elevation of the first sleeve part provided as a stop, in particular whereby an, in particular stabilizing, prestress can be exerted on the plug-in assembly.

In a further embodiment of the angle connector sleeve according to the invention, the first sleeve part, in particular the second subregion of the first sleeve part, can have a guide edge, provided for the purpose of guiding the insertion element along the guide edge during an insertion process, in particular in such a manner that the second sleeve part configured as a half-shell coincides with the second subregion of the first sleeve part configured as a half-shell.

In a further embodiment of the angle connector sleeve according to the invention, the insertion element can be guided along the guide edge during an insertion process in such a manner that the fixing element, in particular the hammer-shaped part of the fixing element, engages in the fixing element counterpart matched to the fixing element, in particular to the hammer-shaped part of the fixing element, and the fixing element counterpart engages behind the fixing element, in particular the hammer-shaped part of the fixing element.

These embodiments of the angle connector sleeve according to the invention have the advantage that the corresponding components can be configured and positioned in such a manner that the first and second sleeve parts can be precisely joined and held together securely without complex alignment. Additionally or alternatively, when the first and second sleeve parts are joined, the plug-in assembly can be accurately positioned in the first sleeve part by the insertion element alone, whereby the plug-in end of the plug-in assembly is automatically pushed out of the push-out opening of the first sleeve part by the intended length. Thus, with these embodiments of the angle connector sleeve according to the invention, the assembly or conversion of a cable connector is facilitated.

In a further embodiment of the angle connector sleeve according to the invention, the cable connector can comprise: a mechanical retaining element which is provided to be blocked by a retaining element counterpart on the built-in connector side with respect to an axial movement in the cable connector withdrawal direction as part of a second locking mechanism which can be actuated by rotation of the cable connector in a screw-in direction when the cable connector is at least partially inserted into the built-in connector, and/or mechanical key elements which are provided to cooperate with matched key element counterparts of the built-in connector in such a manner that the cable connector can be inserted into the built-in connector in only one specific rotational orientation predetermined by the key element counterparts.

In a further embodiment of the angle connector sleeve according to the invention, the mechanical retaining element of the cable connector can be moved by and upon actuation of the second locking mechanism along an oblique course of the retaining element counterpart until the retaining element hits a rotary stop provided in the built-in connector and thus a final insertion position of the cable connector in the built-in connector is reached, and can be configured as a nose arrangement and the retaining element counterpart as a groove arrangement, wherein grooves of the groove arrangement—in the inserted state—first extend axially and thereby serve as key counterparts for the nose arrangement serving in particular as key elements, and then run normally to the axis or slightly obliquely to normally to the axis, wherein upon entering the plug connection, the groove arrangement area extending normally or slightly obliquely to normally to the axis engages behind the nose arrangement and thereby the cable connector is blocked against axial withdrawal, or can be configured as a groove arrangement, wherein grooves of the groove arrangement only extend axially, and thereby serve in particular as key elements for key counterparts of the built-in connector, and then run normally to the axis or slightly obliquely to normally to the axis, wherein the retaining element counterpart is configured as a nose arrangement which is introduced into the groove arrangement by making the plug connection and engages behind the groove arrangement area which runs normally or slightly obliquely to normally to the axis, and the cable connector is thereby blocked against axial withdrawal.

In a further embodiment of the angle connector sleeve according to the invention, the first sleeve part can have indentations and/or protuberances in an opening region radially completely surrounding the push-out opening, wherein the indentations and/or protuberances can be configured as corresponding counterparts to the mechanical key elements and can be provided to cooperate with the key elements in such a manner that the plug-in end of the cable connector can be pushed out through the push-out opening in only one specific rotational orientation predetermined by the indentations and/or protuberances.

In a further embodiment of the angle connector sleeve according to the invention, the plug-in end of the cable connector can be provided, in cooperation with a support skirt area of the built-in connector in the state created by the insertion of the plug connection, to provide a support effect for the cable connector with regard to loading forces acting on the cable connector perpendicular to the insertion direction of the cable connector into the built-in connector.

These embodiments of the angle connector sleeve according to the invention illustrate that the angle connector sleeve is suitable for use as a housing for special cable connectors which can form the mechanically lockable plug connection in a special manner.

In a further embodiment of the angle connector sleeve according to the invention, the first sleeve part and/or the second sleeve part can have a recess for passing through or receiving a fastening means, in particular a screw, intended to at least temporarily fasten the second sleeve part to the first sleeve part. This embodiment describes an alternative fixing of the second sleeve part on the first sleeve part, in particular as an alternative to embodiments in which the fixing is achieved by means of the previously described fixing mechanism with a fixing element and fixing element counterpart.

The invention also relates to a cable connector comprising an angle connector sleeve according to one of the previously described embodiments, in particular wherein the angle connector sleeve is a housing of the cable connector. Thus, the cable connector comprise a flexibly usable housing that is suitable for a plurality of different cable connector types. Furthermore, the cable connector has improved protection against damage.

In an exemplary embodiment of the cable connector according to the invention, a plug-in end of a plug-in assembly of the cable connector can be pushed out of a first sleeve part of the angle connector sleeve through a push-out opening. This embodiment has the advantage that the features characteristic of a particular connector type, which ultimately enable the precise insertion of the mechanically lockable plug connection into the built-in connector matched as a counterpart, such as the radial extension/size and geometric shape of the plug-in end, the positioning and configuration of possible mechanical retaining elements or key elements, etc., are present outside the angle connector sleeve.

In a further exemplary embodiment of the cable connector according to the invention, the cable connector can have a contact element carrier formed as part of the plug-in assembly and arranged at the plug-in end, wherein the plug-in assembly can be received by a first subregion of the first sleeve part of the angle connector sleeve, wherein the first subregion is formed as a completely encased hollow body, in particular a hollow cylinder or hollow cuboid.

In a further embodiment of the cable connector according to the invention, the cable connector can have a through-opening for passing through a cable, wherein the through-opening can be formed by a second subregion of the first sleeve part configured as a half-shell open on one side and a second sleeve part of the angle connector sleeve configured as a half-shell open on one side.

In a further embodiment of the cable connector according to the invention, the cable connector can have a clamping sleeve, wherein a cable connected to a contact element received by the contact element carrier can be passed through an axial passage of the clamping sleeve.

In a further embodiment of the cable connector according to the invention, the cable connector can have a union nut screwed onto a thread arranged on an outer lateral surface of the angle connector sleeve, whereby the clamping sleeve can be pressed against the cable passed through the clamping sleeve and the cable can thereby be blocked with regard to an axial movement in the cable withdrawal direction.

In a further embodiment of the cable connector according to the invention, the cable connector can have an arrangement of components such that the plug-in assembly received by the first subregion of the first sleeve part of the angle connector sleeve can be directed in the axial direction of a second axis which crosses a first axis, in particular including an angle in the range of 45 degrees to 100 degrees, in particular of 90 degrees, wherein the clamping sleeve and/or the union nut can be directed in the axial direction of the first axis.

In a further embodiment of the cable connector according to the invention, the cable passed through the axial passage of the clamping sleeve and connected to the contact element received by the contact element carrier can have a course according to the angle connector sleeve formed as an angled hollow body, in particular at a right angle, in particular wherein the cable can be angled.

### BRIEF DESCRIPTION OF THE DRAWINGS

The angle connector sleeve and the cable connector according to the invention are described in more detail below purely by way of example with reference to exemplary embodiments shown schematically in the figures. The same elements are identified by the same reference numerals in the figures. The described embodiments are generally not shown to scale and are not to be understood as limiting. In detail,

FIG. 1A-1C: show perspective views of an exemplary embodiment of the angle connector sleeve according to the invention, in which the first and second sleeve parts are joined together,

FIG. 2A-2C: show perspective views of an exemplary embodiment of the angle connector sleeve according to the invention, in which the first and second sleeve parts are separated,

FIG. 3A-3C: show perspective views of an exemplary embodiment of the cable connector according to the invention,

FIG. 4A-4B: show perspective views of an exploded view of an exemplary embodiment of the cable connector according to the invention,

FIG. 5: shows a schematic representation of a comparison of two exemplary embodiments of the cable connector according to the invention in the plugged-in state.

### DETAILED DESCRIPTION

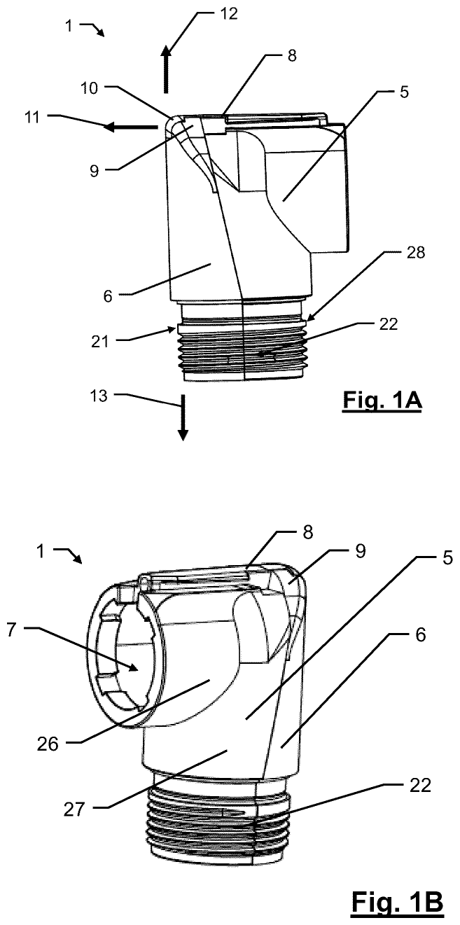

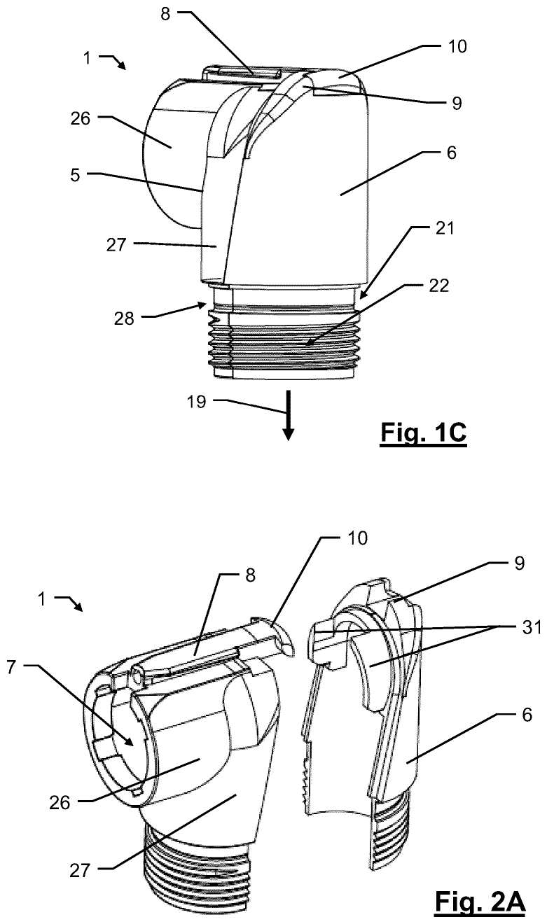

FIGS. 1A to 1C show perspective views of an exemplary embodiment of the angle connector sleeve 1 according to the invention, in which the first sleeve part 5 and the second sleeve part 6 are joined together. In the exemplary embodiment shown in FIG. 1A, the outer lateral surface 28 of the first sleeve part and the outer lateral surface 21 of the second sleeve part each have a portion of the thread 22 onto which the union nut 20 of the cable connector 2 can be screwed. The fixing element 8 engages with its hammer-shaped end piece 10 into the fixing element counterpart 9 matched to the hammer-shaped part 10 of the fixing element 8, and the fixing element counterpart 9 engages behind the hammer-shaped part 10 of the fixing element 8 such that the second sleeve part 6 is fixed on the first sleeve part 5. The second sleeve part is fixed in such a manner that it is blocked with respect to axial movements in the first direction of movement 11, the second direction of movement 12 and the third direction of movement 13.

FIG. 1B also shows that the first sleeve part, in particular the first subregion 26 of the first sleeve part, has the push-out opening 7 and completely surrounds it radially. The contact surface of the first and second sleeve parts 5, 6 runs through the angle connector sleeve 1 in such a manner that—when viewed towards the push-out opening 7—the first subregion 26 and the second subregion 27 of the first sleeve part 5 lie in front of the contact surface and the second sleeve part 6 is configured as a type of rear wall. Consequently, the contact surface does not pass through or intersect the angle connector sleeve 1—when viewed frontally towards the push-out opening 7—sagittally, i.e. from front to back. Thus, the contact surface does not pass through the push-out opening 7, whereby the region of the first sleeve part 5 radially surrounding the push-out opening 7 is not severed and thus an extended plug-in end 3 of the cable connector 2 can be stably supported. The depicted embodiment of the angle connector sleeve according to the invention is configured in such a manner that the first and second subregions 26, 27 enclose an angle of 90 degrees.

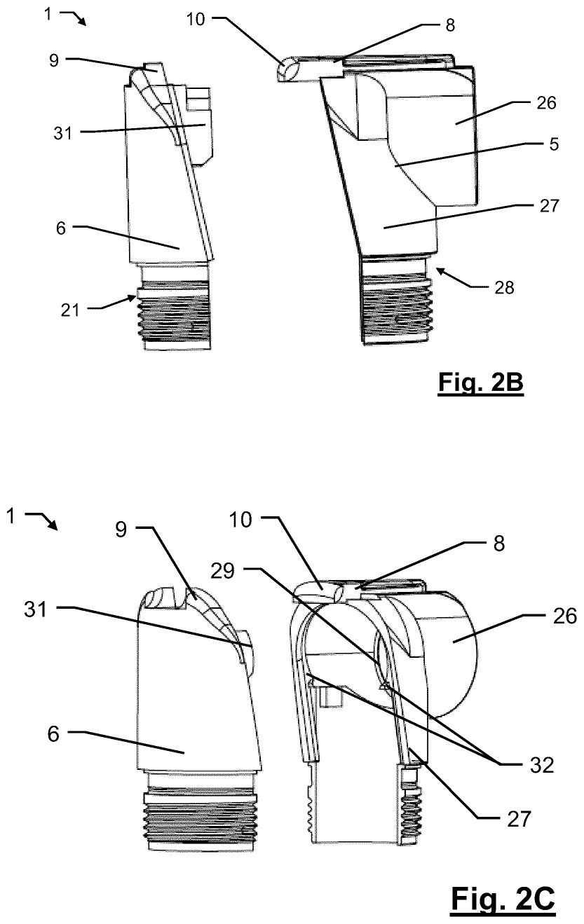

FIGS. 2A to 2C show perspective views of an exemplary embodiment of the angle connector sleeve 1 according to the invention, in which the first sleeve part 5 and the second sleeve part 6 are separate. These figures show that the first subregion 26 is configured as a completely enclosed hollow cylinder, the second subregion 27 as a half-shell open on one side, and the second sleeve part 6 as a half-shell open on one side. The second sleeve part 6 has the rib-like insertion elements 31, which are configured to protrude and are positioned on the second sleeve part 6 in such a manner that, when the two sleeve parts 5, 6 are joined together, they are inserted into the first sleeve part 5 so far that at least one of the insertion elements 31 strikes the plug-in assembly 4, in particular the contact element carrier 16. The plug-in assembly 4 is thereby inserted so far into the first sleeve part 5 that a second elevation 30 arranged on the plug-in assembly 4, in particular on the contact element carrier 16, meets the first elevation 29 of the first sleeve part 5 provided as a stop. The second subregion 27 of the first sleeve part 5 has the guide edges 32, which guide the insertion elements 31 during the insertion process in such a manner that the second sleeve part 6, configured as a half-shell, coincides with the second subregion 27 of the first sleeve part 5, configured as a half-shell.

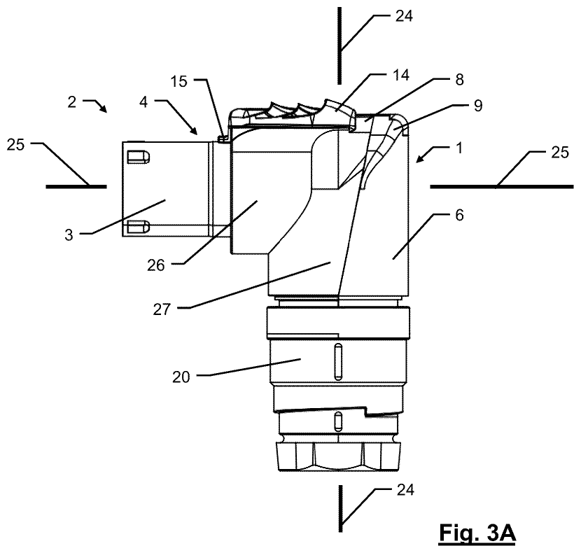

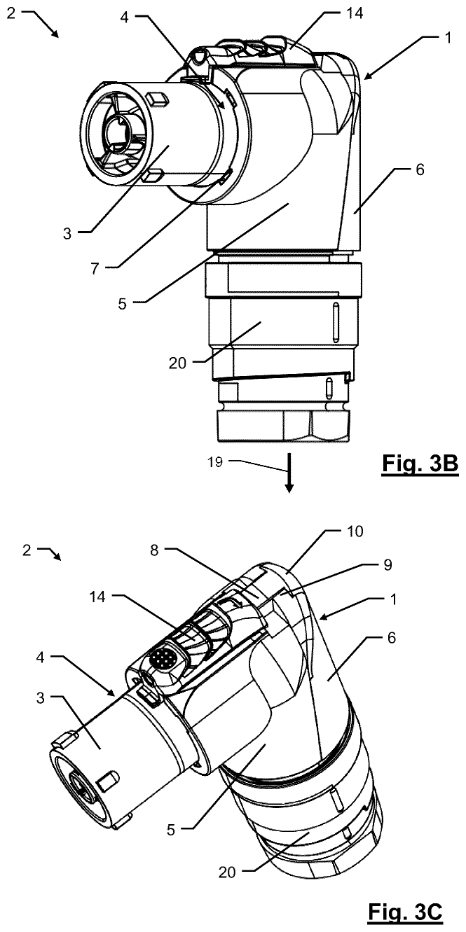

FIGS. 3A to 3C show perspective views of an exemplary embodiment of the cable connector 2 according to the invention, wherein the cable connector 2 has the previously shown embodiment of the angle connector sleeve 1 according to the invention. The plug-in end 3 of the plug-in assembly 4, which, inter alia, has the mechanical retaining elements configured as a nose arrangement and relevant for the insertability into the built-in connector correspondingly configured as a counterpart, is pushed out through the push-out opening 7. The angle connector sleeve 1 itself therefore has no plug-in end. The locking slider 14, on which the bolt 15 is arranged, is in turn arranged on the fixing element 8 and can be moved along the fixing element 8, which functions as a rail, parallel to the insertion direction of the cable connector 2 into the built-in connector. In the embodiment of the cable connector 2 shown, the union nut 20 is screwed onto the thread 22 of the angle connector sleeve 1.

The cable connector 2 shown has an arrangement of components such that the plug-in end 3 is directed in the axial direction of a second axis 25 which crosses the longitudinal axis 24 at an angle of 90 degrees, whilst the union nut 20 of the cable connector 2 is directed in the axial direction of the longitudinal axis 24.

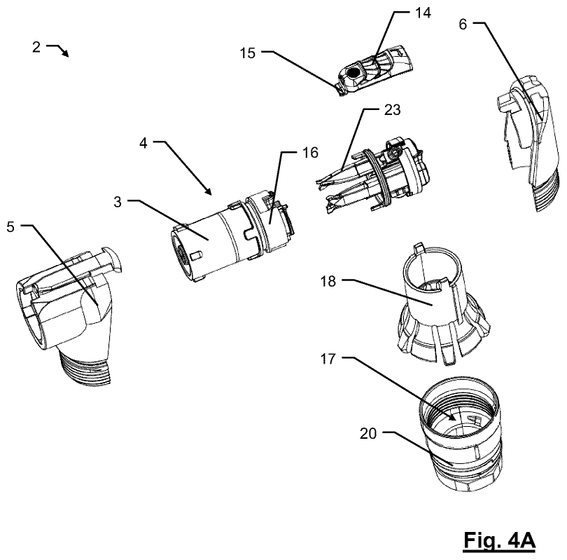

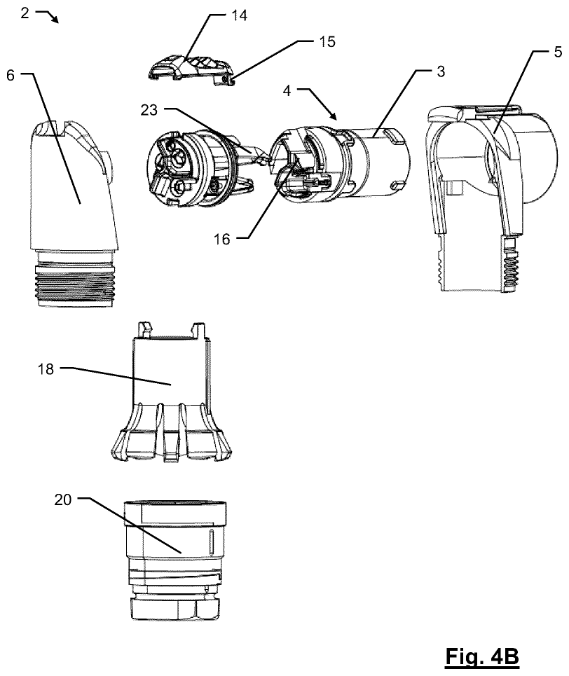

FIGS. 4A and 4B show perspective views of an exploded view of an exemplary embodiment of the cable connector 2 according to the invention to further illustrate the configuration and arrangement of other components of the cable connector 2. Thus, the cable connector 2 shown, in addition to the previously shown embodiment of the angle connector sleeve 1 according to the invention, has the clamping sleeve 18 and three contact elements 23, which are inserted into the contact element carrier 16 formed as part of the plug-in assembly. The clamping sleeve 18 is pressed onto a cable inserted through the through-opening 17 into the cable connector 2 by the union nut 20 screwed onto the thread 22, whereby the cable is additionally fixed within the cable connector.

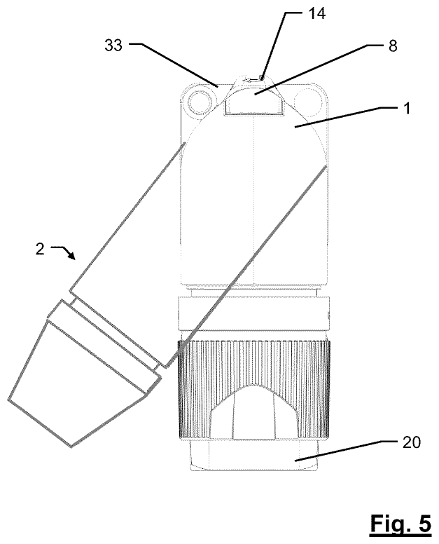

FIG. 5 shows a schematic representation of a comparison of two exemplary embodiments of the cable connector 2 according to the invention in the plugged-in state. On the one hand, the embodiment of the cable connector 2 shown in the preceding figures is shown, in which the fixing element 8 and the locking slider 14 are arranged on the angle connector sleeve 1 (e.g. on top of the first sleeve part 5, in other words in the direction of 12:00 o'clock) in such a manner that when the cable connector 2 is plugged into a built-in connector 33, the angled part of the cable connector 2, which comprises, for example, the clamping sleeve 18, the union nut 20 and the cable feed-through opening 17, runs straight downwards, i.e. in the direction of 6:00 o'clock. On the other hand, a further exemplary embodiment of the cable connector 2 according to the invention is shown as a schematic line drawing, in which the fixing element 8 and the locking slider 14 are arranged on the angle connector sleeve 1 in such a manner (e.g., obliquely on the first sleeve part 5 and thus not in the 12:00 o'clock direction) that, when the cable connector 2 is plugged into the built-in connector 33, the angled part of the cable connector 2, which comprises, for example, the clamping sleeve 18, the union nut 20 and the cable feed-through opening 17, is directed obliquely to the side, for example, in the 8:00 o'clock direction. Naturally, further embodiments of the cable connector 2 are also feasible, in which the angled part has a different course in the plugged-in state, for example, in the 3:00 o'clock, 4:00 o'clock, 9:00 o'clock, 11:00 o'clock direction, etc.

It is understood that these figures only schematically illustrate possible exemplary embodiments. The various approaches can also be combined with each other and with prior art methods.

1. An angle connector sleeve (1) configured as a housing for a cable connector (2) which is adapted to be inserted into a built-in connector matched as a counterpart to form a mechanically lockable plug connection, the cable connector (2) being configured to be inserted into the built-in connector to form a plug-in connection with a plug-in end (3) of a plug-in assembly (4), the angle connector sleeve (1) comprising:
an angled hollow body configured to receive and enclose at least the plug-in assembly (4), the angled hollow body including a first sleeve part (5) and a second sleeve part (6);
the first sleeve part (5) and the second sleeve part (6) are adapted to be joined together along a contact surface running through the angle connector sleeve (1);
the first sleeve part (5) has a push-out opening (7) that is configured such that the plug-in end (3) of the plug-in assembly (4) is adapted to be pushed out from the first sleeve part (5) through the push-out opening (7); and
the push-out opening (7) is completely radially surrounded by the first sleeve part (5).

2. The angle connector sleeve (1) according to claim 1, wherein the first sleeve part (5) comprises a fixing element (8) and the second sleeve part (6) comprises a fixing element counterpart (9) matched to the fixing element (8), the fixing element (8) is provided to engage in the fixing element counterpart (9) matched to the fixing element (8) as part of a fixing mechanism and the fixing element counterpart (9) is provided to engage behind the fixing element (8) as part of the fixing mechanism, in order to fix the second sleeve part (6) on the first sleeve part (5).

3. The angle connector sleeve (1) according to claim 2, wherein the fixing element (8) includes a hammer-shaped part (10) that is engages in the fixing element counterpart (9), and the fixing element counterpart (9) is configured to engage behind the hammer-shaped part (10) of the fixing element (8).

4. The angle connector sleeve (1) according to claim 2, wherein the angle connector sleeve (1) has a locking slider (14) which is provided to engage, within a framework of a first locking mechanism which is actuatable by moving the locking slider (14), with a bolt (15) connected to the locking slider (14) in a closing element on a side of the built-in connector to block the cable connector (2) with regard to rotation in an unscrewing direction, which is directed opposite to a screwing-in direction.

5. The angle connector sleeve (1) according to claim 3, wherein the fixing element (8) is configured and arranged on the first sleeve part (5) such that the locking slider (14) is arrangeable on the fixing element (8) and is movable along the fixing element (8) parallel to an insertion direction of the cable connector (2) into the built-in connector.

6. The angle connector sleeve (1) according to claim 1, further comprising the cable connector (2) which includes:
a contact element carrier (16) formed as part of the plug-in assembly (4) and arranged at the plug-in end (3), configured to receive a contact element (23) and to fix the contact element within the cable connector (2);
wherein the contact element (23) is provided to come into contact with a contact element counterpart on a built-in connector side by forming the mechanically lockable plug connection and thereby to provide signal transmission across the plug connection;
a cable connected to the contact element (23);
a feed-through opening (17) for passing through the cable;
a clamping sleeve (18) having an axial passage for the cable and configured to be pressed against the cable passed through the feed-through opening (17) and through the clamping sleeve (18) to block the cable with respect to an axial movement in a cable withdrawal direction (19); and
a union nut (20) configured to be screwed onto a thread (22) arranged on an outer lateral surface (21, 28) of the angle connector sleeve (1), by which the clamping sleeve (18) is pressed onto the cable passed through the clamping sleeve (18).

7. The angle connector sleeve (1) according to claim 1, further comprising the cable connector, and the cable connector (2), before receiving and enclosing at least the plug-in assembly (4) through the angle connector sleeve (1), has a first arrangement of components that direct the plug-in end (3) in an axial direction of a longitudinal axis (24) of the cable connector (2), and by receiving and enclosing at least the plug-in assembly (4) by the angle connector sleeve (1), has a second arrangement of components that direct the plug-in end (3) in an axial direction of a second axis (25) which crosses the longitudinal axis (24).

8. The angle connector sleeve (1) according to claim 7, wherein the second axis (25) crosses the longitudinal axis (24) at an angle in a range from 45 degrees to 100 degrees, and at least one further component of the cable connector (2) is also directed in the axial direction of the longitudinal axis (24) of the cable connector (2).

9. The angle connector sleeve (1) according to claim 1, wherein the angle connector sleeve (1) consists of plastic.

10. The angle connector sleeve (1) according to claim 1, wherein
the first sleeve part (5) located in front of a contact surface when viewed towards the push-out opening (7) is formed with a first subregion (26) and a second subregion (27), the first and the second subregion (26, 27) are arranged such that they enclose an angle in a range of 45 degrees to 100 degrees, the first subregion (26) is formed as a completely encased hollow body, and the second subregion (27) is formed as a half-shell, which, when viewed towards the push-out opening (7), is formed behind the second sleeve part (6) lying on the contact surface as a half-shell.

11. The angle connector sleeve (1) according to claim 10, wherein the second subregion (27) of the first sleeve part (5) and the second sleeve part (6) have a part of a thread (22) on a respective outer lateral surface (21, 28), wherein, when the first sleeve part (5) and the second sleeve part (6) are joined together, the parts of the thread (22) are arranged such that a union nut (20) is screwable onto the thread (22), and the union nut (20) is configured to fix the second sleeve part (6) on the first sleeve part (5).

12. The angle connector sleeve (1) according to claim 1, wherein a first elevation (29) is arranged within the first sleeve part (5), and is adapted to provide a stop for a second elevation (30) arranged on the plug-in assembly (4), whereby the plug-in end (3) is only be pushable out of the first sleeve part (5) by a defined length through the push-out opening (7).

13. The angle connector sleeve (1) according to claim 1, wherein the second sleeve part (6) has an insertion element (31) configured to be inserted into the first sleeve part (5) and to align the second sleeve part (6) relative to the first sleeve part (5).

14. The angle connector sleeve (1) according to claim 13, wherein the second sleeve part (6) is configured as a half-shell and coincides with a second subregion (27) of the first sleeve part (5) configured as a half-shell.

15. The angle connector sleeve (1) according to claim 13, wherein a first elevation (29) is arranged within the first sleeve part (5), and is adapted to provide a stop for a second elevation (30) arranged on the plug-in assembly (4), whereby the plug-in end (3) is only be pushable out of the first sleeve part (5) by a defined length through the push-out opening (7), and the insertion element (31) is configured to strike the plug-in assembly (4) when inserted into the first sleeve part (5) and to thereby insert the plug-in assembly (4) so far into the first sleeve part (5) that the second elevation (30) arranged on the plug-in assembly (4) strikes the first elevation (29) of the first sleeve part (5) provided as the stop, such that a stabilizing prestress is exertable on the plug-in assembly (4).

16. The angle connector sleeve (1) according to claim 15, wherein the first sleeve part (5) located in front of a contact surface when viewed towards the push-out opening (7) is formed with a first subregion (26) and a second subregion (27), the first and the second subregion (26, 27) are arranged such that they enclose an angle in a range of 45 degrees to 100 degrees, the first sleeve part (5) has a guide edge (32), provided for guiding the insertion element (31) along the guide edge (32) during an insertion process, such that the second sleeve part (6) configured as a half-shell coincides with the second subregion (27) of the first sleeve part (5) configured as a half-shell.

17. A cable connector (2) comprising the angle connector sleeve (1) according to claim 1.

18. The cable connector (2) according to claim 17, wherein the plug-in end (3) of the plug-in assembly (4) of the cable connector (2) is pushed out of the first sleeve part (5) of the angle connector sleeve (1) through the push-out opening (7).
